(19) United States
(12) Patent Application Publication
(10) Pub. No.: US 2007/0193834 A1
(43) Pub. Date: Aug. 23, 2007

(54) System and method for remotely attended delivery

(75) Inventors: Samuel Hong-Yen Pai, Boca Raton, FL (US); Robert L. Hansen, Plainfield, IL (US); Walter T. Schneider, Elburn, IL (US); Richard D. Hewitt, Waukesha, WI (US); Gene C. Brierton, Schaumburg, IL (US); Michael J. Welf, Homewood, IL (US)

Correspondence Address: CHRISTOPHER & WEISBERG, P.A., 200 EAST LAS OLAS BOULEVARD, SUITE 2040, FORT LAUDERDALE, FL, 33301, US

(73) Assignee: ADT Security Services, Inc.

(21) Appl. No.: 11/708,236

(22) Filed: Feb. 20, 2007

Related U.S. Application Data
(60) Provisional application No. 60/775,631, filed on Feb. 21, 2006.

(51) Int. Cl. B65G 47/00

(52) U.S. Cl. 186/3

(57) ABSTRACT

A method and system for remotely monitoring deliveries, the method and system include detecting an arrival of a delivery at an access point and notifying a monitoring center of the arrival of the delivery at the access point. The method and system include verifying at least one verification detail, which correlates to the delivery, and sending a configuration signal from the monitoring center to the access point, which has instructions for controlling an entrance at the access point. The method and system can further include sending a second configuration signal from the monitoring center to the access point, which has instructions for controlling an entrance at the access point upon completion of the delivery. The method and system can further include sending an indication signal from the monitoring center to the access point, which has instructions for controlling an indicator at the access point.

### CROSS-REFERENCE TO RELATED APPLICATION

This application is related to and claims priority to U.S. Provisional Patent Application Ser. No. 60/775,631, filed Feb. 21, 2006, entitled SYSTEM AND METHOD FOR REMOTE UNATTENDED DELIVERY, the entirety of which is incorporated herein by reference.

### STATEMENT REGARDING FEDERALLY SPONSORED RESEARCH OR DEVELOPMENT

n/a

### FIELD OF THE INVENTION

The present invention relates to security monitoring and in particular to a system and method that allows deliveries to be made at any time without the need for business personnel at the delivery site.

### BACKGROUND OF THE INVENTION

Delivery and pick-up of goods when the receiving business is closed are expensive due to the need for a business representative to be in attendance during the process. However, deliveries and pick-ups made during business hours can be disruptive to the business and adversely impact the flow of traffic around the business. Also, business hour deliveries for carriers are expensive since traffic congestion reduces delivery efficiency because the number of possible deliveries in a shift is reduced. If a delivery/pick-up cannot be made, either the recipient, the sender or the carrier has to bear the cost of a re-delivery/pick-up attempt.

While off-hours delivery can aid delivery efficiency, the hijacking of cargo at the delivery point is also of concern because it jeopardizes the safety of the driver and also the delivery of the goods. A current solution to off-hours deliveries is to have a second person, such as a representative of the receiving business, at the delivery location. Often, delivery companies use two drivers for off-hours deliveries, thereby further increasing delivery costs. In the alternative, deliveries are made during business hours, and the problems noted above are present.

Another solution that has been tried for off-hours unattended delivery is the use of a “lock-box” for which the delivery person and the recipient have a password/key. However, if the delivery person and the recipient do not have correct password/key, the delivery attempt will fail or the recipient may not be able to access the delivery. Problems with the “lock box” approach include the coordination of keys/passwords, providing an adequately sized delivery box, the inability to secure the box to the premises and secure access to the delivery location, providing refrigeration at the point of delivery, safety of driver and preventing hijacking of cargo just prior to delivery to the lock box.

It is desirable to have a system and method that addresses the above-described problems and allows the delivery of goods in a safe and secure manner without the need for the presence of a representative of the business or other personnel. It is also desirable to have a system and method that allows the ability to generate reports based on the details of the delivery and whether or not the detailed delivery requirements were met.

The present invention addresses the deficiencies of the art in respect to allowing deliveries to be made and goods picked-up without the need to have personnel at the point of delivery. It is to be understood that the descriptions made herein are exemplary and explanatory only and are not restrictive of the invention.

### SUMMARY OF THE INVENTION

The present invention advantageously provides a method and system for remotely monitoring deliveries.

The method for remotely monitoring deliveries includes detecting an arrival of a delivery at an access point and notifying a monitoring center of the arrival of the delivery at the access point. The method includes verifying at least one verification detail, which correlates to the delivery, sending a configuration signal from the monitoring center to the access point, which has instructions for controlling an entrance at the access point, and sending an indication signal from the monitoring center to the access point, which has instructions for controlling an indicator at the access point. The method can further include sending a second configuration signal from the monitoring center to the access point, which has instructions for controlling an entrance at the access point upon completion of the delivery.

In accordance with another aspect, the present invention provides a monitoring center for monitoring and controlling customer premises equipment that includes a monitoring server that contains a monitoring application, a database for recording delivery data, and a monitoring terminal in communication with the monitoring server, the database, the at least one communication network and the customer premises equipment, in which the monitoring server receives a notification of an, arrival of a delivery at an access point of the customer premises equipment, and verifies at least one verification detail that correlates to the delivery.

In accordance with still another aspect, the present invention provides a system for remotely monitoring deliveries, the system includes customer premises equipment that has an access control system that includes a notification input device and a notification indicator, the access control system controls access to at least one door entrance of the customer premises equipment, and a monitoring center for monitoring and controlling the customer premises equipment that includes a monitoring server containing a monitoring application, a database for recording delivery data, and a monitoring terminal in communication with the monitoring server, the database and the at least one communication network, in which the monitoring terminal receives a notification of an arrival of a delivery at the at least one door entrance of the customer premises equipment, and verifies at least one verification detail that correlates to the delivery.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a block diagram of a remotely monitored delivery system constructed in accordance with the principles of the present invention;

FIG. 2 is a block diagram of an exemplary installation of customer premises equipment constructed in accordance with the principles of the present invention;

FIG. 3 is a block diagram of another exemplary installation of customer premises equipment constructed in accordance with the principles of the present invention; and

FIG. 4 is a flowchart of a remotely monitored delivery process in accordance with the principles of the present invention.

### DETAILED DESCRIPTION OF THE INVENTION

As an initial matter, the terms “delivery” and “deliveries” as used herein also includes pick-up of goods and products and is used generally to refer to access to a designated goods exchange location. The present invention advantageously provides a method and system that allows remotely attended deliveries and provides reports based on the details of the delivery and whether or not the detailed delivery requirements were met. The present invention advantageously allows the deliveries to occur without the expense of having a business representative in attendance. The present invention accomplishes this result through the use of a remote video and/or audio monitoring system in conjunction with access control devices and audio feedback at the receiving area to manage the delivery of goods while maintaining the security of the location and the delivery person.

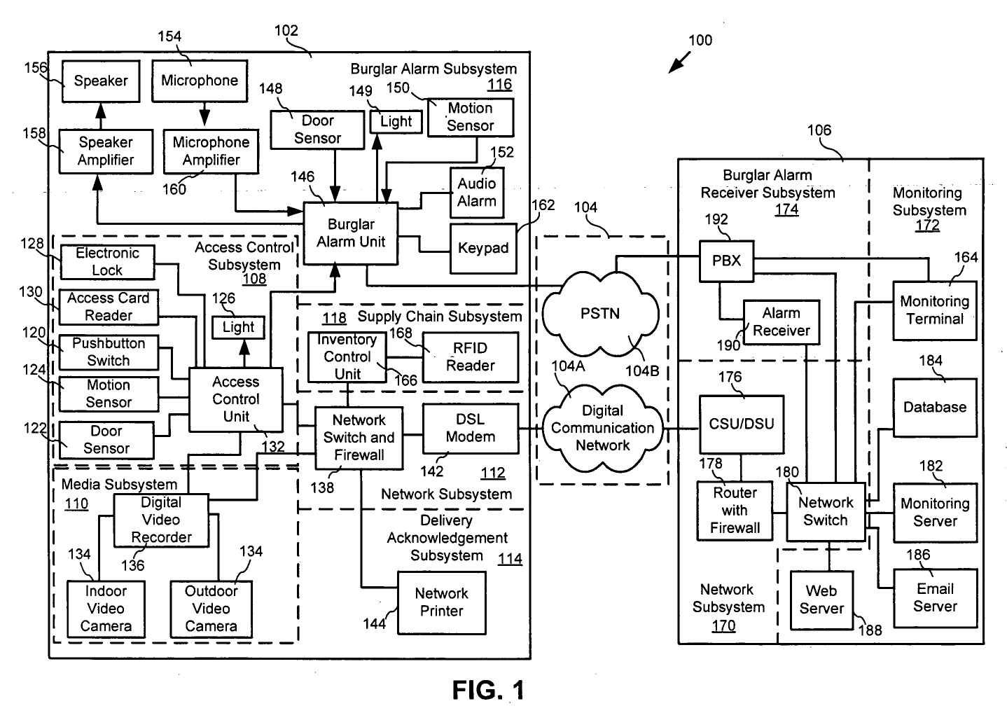

Referring now to the drawing figures in which like reference designators refer to like elements there is shown in FIG. 1 a system 100 constructed in accordance with the principles of the present invention. The three elements of the system 100 of the present invention include customer premises equipment 102 (“CPE”), a communications network 104, such as the Internet 104A and/or the Public Switched Telephone Network 104B (“PSTN”), and a monitoring center 106. Of note, while the communications network 104 can be IPv4 based, it is contemplated that the communications network 104 can be an IPv6 based system as may be used in future Internet implementations. Wireless connections, such as cellular-based broadband data connections, can also be used as the communications network 104.

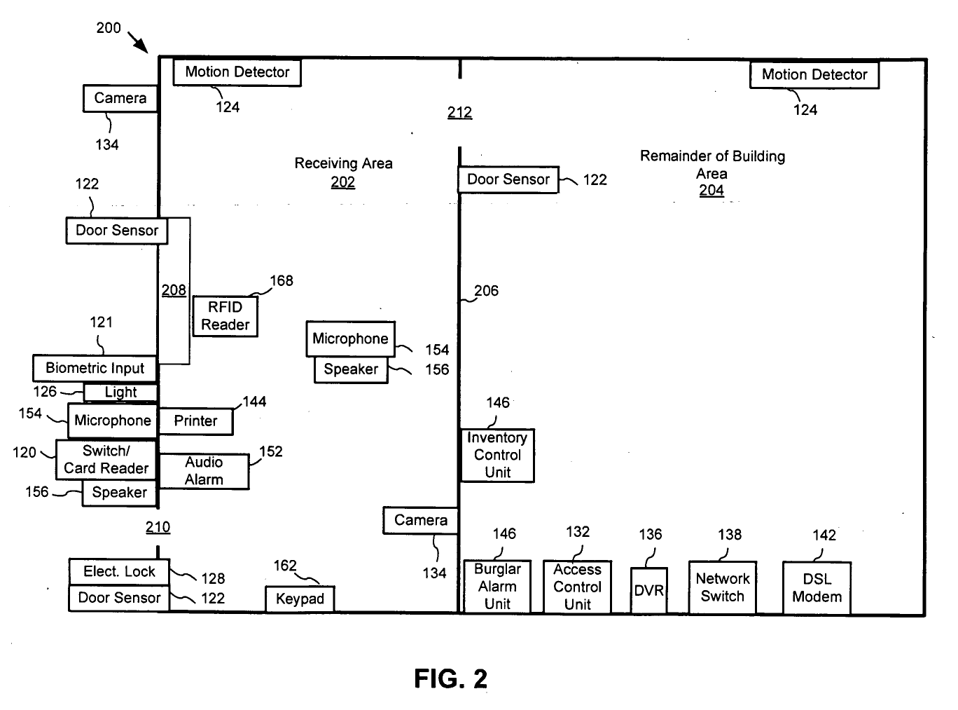

Customer premises equipment 102 includes three subsystems, namely access control 108, media 110, and network communication 112. Customer premises equipment 102 can also include a delivery acknowledgement subsystem 114, a burglar alarm subsystem 116 and a supply chain subsystem 118. In one embodiment, the access control subsystem 108 includes pushbutton switches 120, biometric input devices 121, door sensors 122, motion sensors 124, indicator lights 126, electronic door locks 128, access card readers 130 and an access control unit 132. The access control unit 132 can be of the type known in the art that is able to accept switch/relay inputs as well as provide relay outputs. Other standard interfaces on the access control unit 132 include serial and parallel interfaces such as may be found on access card readers 130. A pushbutton switch 120 used in accordance with the present invention is suitably weatherproofed since it is typically installed on the exterior of a building. Biometric input device 121 may include a fingerprint, palm, palm surface vein, hand geometry or iris scanner, an input pad for signature verification, a camera for facial recognition and a microphone for voice recognition. Door sensors 122 can be reed switches that are activated by the presence of a magnet installed on the door. Additionally, door sensors 122 can be coupled to access control unit 132 either directly or by a door management alarm unit (not shown). The motion sensors 124 can be infrared and/or microwave units capable of detecting motion in the receiving area 202 (FIG. 2) and further provide a relay-driven output signal to a central control unit 132. The indicator lights 126 are lights that are activated by the relay output of the control unit 132. Similarly, the electronic door locks 128 can either be a controlled latch lock or a magnetic lock.

In one embodiment, the access card reader 130 is a short range reader that uses radio frequencies (“RF”) to energize a proximity card when the card is placed within the RF field of the reader, which causes the card to then emit a radio signal containing the ID number of the card. This technique is also known as RFID.

Instead of a pushbutton switch 120 used to notify the monitoring center 106 of a delivery attempt, it is contemplated that notification can be sent from the delivery agent using a wireless communication link. For example, a wireless transmitter carried by the driver can be wirelessly linked to receivers at the delivery location 200. The delivery agent can then drive up to the delivery location 200 and without leaving the truck, notify the monitoring center 106 that he is on site. A lamp, strobe or other visual and/or audio indication can be provided so that the delivery agent knows that the monitoring center 106 is aware of his presence. This will allow the delivery agent to exit the delivery vehicle and verify with 2-way audio and/or video that he is being monitored.

The media subsystem 110 has indoor or outdoor cameras 134, as may be appropriate for the mounting location, and a digital video recorder 136 (“DVR”). The cameras 134 can be analog color cameras that are able to capture VGA-like resolutions (480 lines) or otherwise provide enough detail to allow for the discrimination of the necessary image details. The DVR 136 is used to capture, digitize and store the image captured by the analog cameras 134. Alternatively, an analog-to-digital video encoder (not shown) can be used to digitize the image data for transmission to the monitoring center 106 instead of the DVR 136 if local recording of the video is not required. As still another alternative, digital cameras with appropriate resolutions can be used. Use of digital cameras allows the direct transmission of image data to the monitoring center 106 where it can be stored and/or further processed. It is also noted that, in either the digital or analog case, black/white cameras can be used to reduce implementation cost and bandwidth requirements. Use of Pan/Tilt/Zoom cameras can allow the remote agent to receive more details about the delivery. Media subsystem 110 provides for archiving of video and audio locally via DVR 136 or a voice recorder. Database 184 provides for archiving of video and audio remotely at the monitoring center 106.

Network subsystem 112 includes those components used to interface the customer location 200 (FIG. 2) to communications network 104 such as a network switch 138 with a firewall and a standard DSL modem 142. Of course, it is contemplated that other networking technologies can be used such as a cable modem, leased line connection, wireless network hardware, etc.

Delivery acknowledgement subsystem 114 includes a network printer 144 to print delivery confirmation receipts that the delivery person can take with them once a delivery has been verified. One embodiment uses a strip printer that prints on thermal paper that has a network interface such as an Ethernet interface. Data to be printed is sent directly to the printer 144 from the monitoring application via the communication network 104. An exemplary format is standard ASCII data sent in the sequence to be printed.

Burglar alarm subsystem 116 includes a burglar alarm (“BA”) unit 146, door sensors 148, motion sensors 150, an audio alarm 152, a microphone 154, a speaker 156, speaker amplifiers 158, microphone amplifiers 160, and a keypad 162. The speakers 156 and speaker amplifiers 158 are known parts of a sound system appropriate for use in carrying voice messages. The microphone 160 is an omni-directional microphone capable of capturing voices/sounds in the receiving area 202. A microphone amplifier 158 controllable by the remote agent can be used to obtain a desired level of audio sensitivity. It is contemplated that the audio communications can be bi-directional to allow communication between the delivery agent and the monitoring agent. Both omni-directional and bi-directional audio communications can be recorded and played locally at the customer premises equipment 102 and remotely at the monitoring center 106. Of course, a bi-directional video link can also be implemented to allow the monitoring agent and the delivery agent to observe each other.

Door sensors 148 and motion sensors 150 are similar to those used for the access control subsystem 108. These sensors detect when an intrusion has occurred and the burglar alarm unit 146 activates the audio alarm 152 on premises if the proper code is not entered on the keypad 162 within a short period of time. Burglar alarm subsystem 116 may also notify a central monitoring station 164 of the intrusion via a connection to the PSTN 104B so that appropriate action can be taken by a monitoring agent. In an alternate embodiment, the burglar alarm unit 146 uses the Internet 104A (or other digital network) instead of the PSTN 104B to communicate with the monitoring application at the monitoring center 106.

When the burglar alarm subsystem 116 is not implemented, the 2-way audio function can be implemented using an audio encoder/decoder to convert the audio signals to and from the digital signals required for transport between the customer premises, i.e., the delivery location and the monitoring center 106. Similarly, bi-directional digital or digitized analog video can be implemented using digital video cameras or encoders/decoders.

Supply chain subsystem 118 includes an inventory control unit 166 and an RFID reader 168. When goods that have been tagged with an RFID device are in range of reader 168, the tag ID number and any information stored on the tag is transferred to the inventory control unit 166. The data can then be sent to the monitoring center 106 for comparison with the expected goods to be delivered. Alternatively, a barcode reader can be used to identify the goods being delivered. This arrangement allows the ability of tracking the actual delivered goods to be sure that what was expected was actually delivered. In addition, this arrangement provides for the security of other goods that may be in the receiving area 202 of the customer location 200.

Interconnections between the above-described components of the customer premises equipment 102 use technologies appropriate for the type of signals being transmitted, e.g., coaxial cable for analog video, and Cat5e Ethernet cable or wireless communications for data. As an alternative, wireless technology, such as commercially available wireless devices using proprietary or standard wireless signaling technologies, can be used to reduce the need for wires in an installation. Outdoor peripherals such as the pushbutton switches 120 and cameras 134, which are difficult to wire, are prime candidates for wireless connections.

Continuing to refer to FIG. 1, monitoring center 106 includes a network subsystem 170, a monitoring subsystem 172, and, where burglar alarm monitoring is included as an aspect of the system, a burglar alarm receiver subsystem 174. The network subsystem 170 has those components needed to interconnect the monitoring center 106 to the communication network 104 such as hardware as may be known in the art appropriate to support an Internet connection such as a channel service unit/data service unit 176 (“CSU/DSU”), a router with firewall 178, and network switches 180.

Monitoring subsystem 172 includes a monitoring server 182 containing the monitoring application, a database 184 for recording delivery data that includes received audio and video, a monitoring terminal 164 to operate, monitor, and administer the system, an email server 186 to send reports and a web server 188 for data input and report viewing. Servers of one embodiment of the present invention use one or more personal computers running a Unix-based operating system. The monitoring terminals 164 can be desktop or laptop personal computers running a web browser client application that communicates with the monitoring application on the monitoring server 182. In some embodiments, multiple monitoring terminals 164 are located at monitoring center 106 and at remote locations such as other monitoring centers or the location of the customer premises equipment 102. Each monitoring terminal 164 provides for simultaneous remote monitoring of customer premises equipment 102 by multiple users of the monitoring subsystem 172. In some embodiments, a master monitoring terminal 164 is configured such that the monitoring agent at this terminal has master control over the other monitoring terminals 164 and can dictate which terminals can monitor or issue commands to the customer premises equipment 102. For example, a user at master monitoring terminal 164 can bump another user at one of the multiple monitoring terminals 164 in monitoring center 106 to control a monitoring session with customer premises equipment 102.

Monitoring subsystem 172 can also issue trouble signals for system malfunctions. For example, a monitoring terminal 164 loses its monitoring connection with customer premises equipment 102 or a video camera 134 ceases to transmit its video feed to the monitoring center 106. In another example, monitoring subsystem 172 issues trouble signals when the burglar alarm subsystem 116 can not be unarmed or rearmed. In another example, monitoring subsystem 172 issues trouble signals when the burglar alarm subsystem 116 has a low battery condition. It should be noted that monitoring subsystem 172 can issue trouble signals for a variety of malfunctions of monitoring center 106, and/or customer premises equipment 102, including trouble signals generated by the customer premises equipment and sent via the communication network 104, and the above examples are meant to be exemplary only and in no way meant to be limiting.

Burglar alarm receiver subsystem 174 includes a commercially available alarm receiver 186 that connects to the PSTN 104B via a private branch exchange 186 (“PBX”) and accepts alarm signals from the CPE burglar alarm unit 146. Burglar alarm receiver subsystem 174 transmits the alarm signals via the networking subsystem 170 to the monitoring application that is running on the monitoring server 182.

An exemplary installation of the customer premises equipment 102 of the present invention at a customer location 200 is shown in FIG. 2. Customer location 200 has a receiving area 202 separate from the remainder of the building 204. In this embodiment, a dividing wall 206 functions to provide for the separation of receiving area 202 from the remainder of the building 204. Receiving area 202 includes a loading dock entrance 208 and a door entrance 210. Another door entrance 212 serves as a physical access point to the reminder of the building 204. A door sensor 122 is placed at each of the door entrances 208, 210 and 212 to sense the position of these doors and provide door status information to access control unit 132 and burglar alarm unit 146. Electronic locks 128 can be installed at the door entrances 208, 210 and 212 to allow a monitoring agent to remotely unlock/open the doors for the delivery person. In one embodiment, the monitoring agent can remotely disarm a door alarm, provide an indication of the disarming to the delivery person and unlock/open the door by using a motorized door. Outside of the customer premises 200, several different types of access and monitoring devices can be used, such as switch 120 and/or card reader 130, microphone 154, speaker 156, cameras 134 and lights 126. These devices function as described above with reference to FIG. 1. In this embodiment, the access control unit 132, DVR 136, network switch 138, DSL modem 142 and inventory control unit 146 are placed in the remainder of the building area 204. These devices function as described above with reference to FIG. 1. Of course, some or all of these network, control and monitoring units can be distributed in the receiving area 202 if desired.

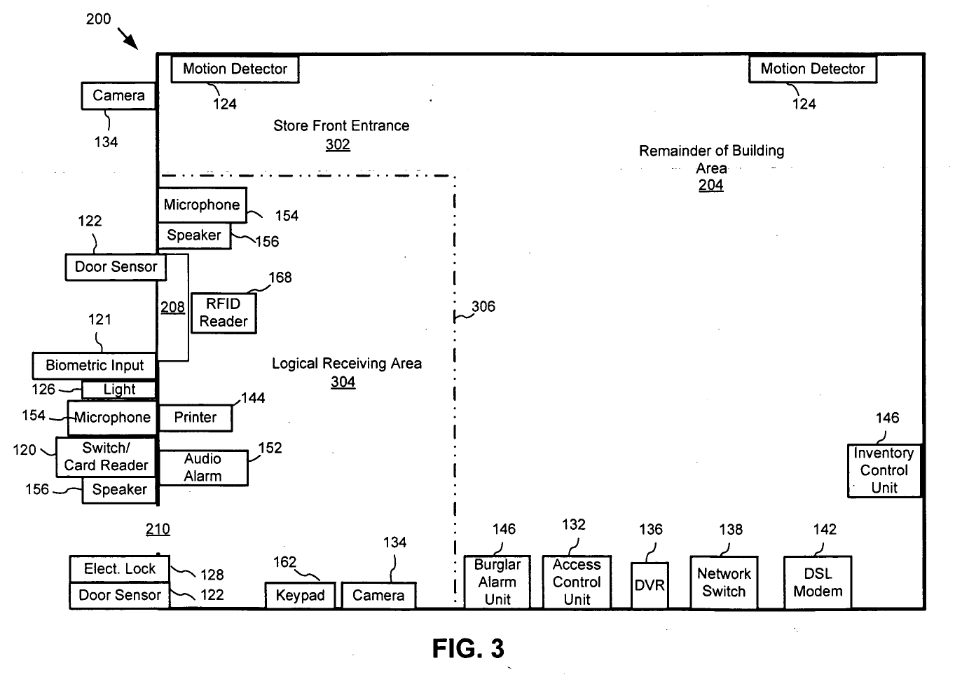

Another exemplary installation of the customer premises equipment 102 of the present invention at a customer location 200 is shown in FIG. 3. In this embodiment, customer location 200 is a store space having a logical receiving area 304 that is logically partitioned off from the store front area 302 and the remainder of building area 204. Several commercially available detection systems can be used to provide the partitioning function such as by generating optical signals by a laser device, or using one or more passive infra-red (“PIR”) detectors to create one or more logical walls 306 that defined the logical receiving area 304. During delivery, the delivery person is forced to restrict his movements to the logical receiving area 304 while the other areas of customer location 200, e.g., the rest of the store front area 302 and the remainder of building area 204, can remain secured.

In another embodiment of the present invention, the delivery vehicle driven by the delivery person includes some of the networked resources of the customer premises equipment 102, namely microphones 154 and cameras 134 mounted in the cargo area and/or the cab of the transportation vehicle. The delivery vehicle can include an onboard computer that includes an electronic version of the freight manifest and/or an event history, e.g., cargo door activations, which can be provided to monitoring center 106 when the transportation vehicle arrives and communications with the customer premises equipment at the customer access point 200. In this embodiment, the communication of the delivery vehicle data to the monitoring center 106 is sent from the delivery vehicle using a wireless communication link. For example, a wireless transmitter that is integrated into the onboard computer can be wirelessly linked to receivers at the delivery location.

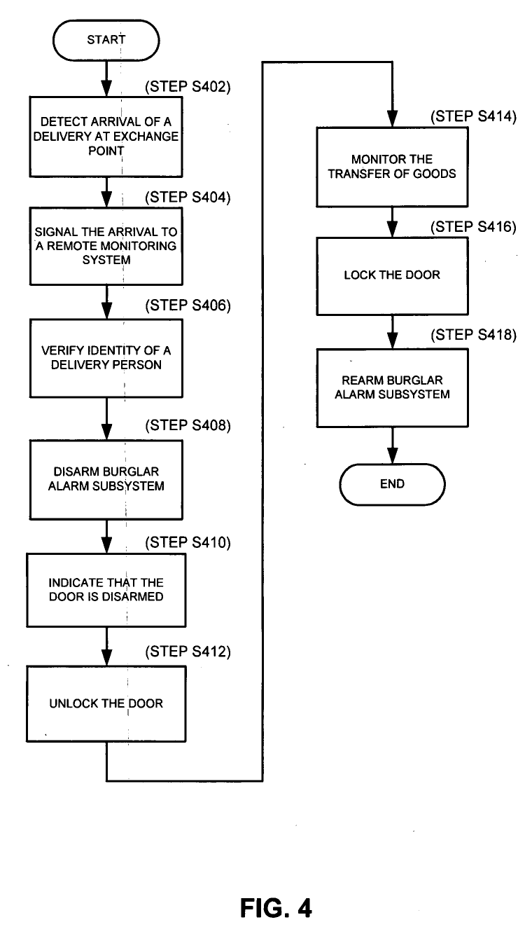

The operation of an embodiment of the remotely monitored delivery system 100 is discussed with respect to the flowchart of FIG. 4. At step S402, the arrival of a delivery is detected at an exchange point, e.g., the loading dock door 208 of a customer's premises 200. The detection of the arrival of a delivery can be accomplished by having the delivery person press a button 120 next to the door 208. At step S404, the arrival of the delivery is signaled to the remote monitoring center 106. For example, access control unit 132 can detect the button 120 push event and send a signal to the remote monitoring center 106 via the communication network 104 indicating that the button 120 has been pushed along with an alphanumeric character string identifying the location of the access/delivery point.

At step S406, the identity of the delivery person is verified. In this embodiment, a monitoring application running on the monitoring server 182 uses the received location ID string and the button 120 push signal indication, and looks up the relevant information from the database to access the digital video recorder 136 (“DVR”), and signals one of the monitoring terminals 164 that a button 120 has been pushed. Internet Protocol (“IP”) cameras can also be used to generate and transmit video information to the monitoring center 106 rather than using DVRs to capture video and digitize it for transmission to the monitoring center 106. In another embodiment, the identity of the delivery person can be verified by using an access card and access card reader 130 (as described above) instead of a pushbutton 120, which would have the added benefit of identifying the delivery person as well as detecting the arrival of a delivery. The ID number of the access card can also be transmitted along with the signal from the access control unit 132 to the monitoring center 106. The card ID can be used to look up the delivery person in the database 184 that would include the name for confirmation purposes. The database 184 can also include a picture of the person for comparison with the delivery person.

After the monitoring application in this embodiment connects the video from the DVR 110 to the selected monitoring terminal 164, the human agent operating the monitoring terminal 164 can verify the identity of the delivery person. Once the delivery person has been verified, the human agent uses the monitoring application to send signals to disarm the alarm system 116 associated with the delivery location door 206 so that the door sensors 122 do not trigger an alarm (step S408). Of note, during the delivery, motion and/or door sensors not in the receiving area 202 can remain activated to ensure that the delivery person restricts his movement only to the receiving area. The monitoring application also turns on an indicator 126 at the delivery location to let the delivery person know that the door has been disarmed (step S410). At step S412, the door 206 can be unlocked either locally by the delivery person or remotely by the human agent. While the system is disarmed, the remote agent can use the audio and video signals provided by the equipment at the delivery location to monitor the progress of the delivery at and around the receiving area 202 (step S414).

Once the delivery is completed, the delivery person locks the door 206 (step S418) and the remote agent uses the monitoring application on the monitoring server 182 to send another signal that rearms the alarms connected to the doors and motion sensors (step S416). Should the delivery person require some type of receipt that the delivery was made, the remote monitoring center 106 causes the network printer 144 at the receiving area 202 to print a receipt. Using the monitoring application, the steps in the delivery process along with a time stamp are recorded in the database 184 at the monitoring center 106.

Delivery details such as schedules, manifests, carrier, driver, etc. can be uploaded to a web page and into the database 184 for later comparison of a delivery and can also serve as verification details. Verification details include personnel identifiers such as PIN codes, ID cards, RFID tokens and the like, biometric identifiers such as facial features, fingerprints, iris prints, palm prints, hand geometry, palm surface vein prints and the like, and vehicle or goods identifiers such as barcodes, RFID tags, license plates, and the like. Reports regarding deliveries can be generated and organized by: delivery location, time, type of delivery, supplier, carrier, etc., and any combination thereof. These reports can be made available via email or at a web site. The reports can include links to video clips of the deliveries, especially if deviations from normal procedures are observed.

The present invention advantageously provides a system and method that obviates the need for a business representative to be present and obviates the need for multiple drivers or delivery agents for a single delivery. Deliveries can be scheduled at any time that fits the operating schedule. The delivery process of the present invention can be actively monitored, ensuring the safety of the delivery person and goods being delivered. Similar to having a business representative present, any problems that occur can be dealt with immediately, such as a medical problem or a holdup/hijack situation. The video monitoring aspect of the present invention also allows a remote person to monitor more deliveries in the same period of time that would have been spent by a business representative. Of note, although the present invention was described with respect to package delivery, it is contemplated that the present invention can also be used in connection with package pick-up.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A method for remotely monitoring deliveries, the method comprising:
detecting an arrival of a delivery at an access point;
notifying a monitoring center of the arrival of the delivery at the access point;
verifying at least one verification detail, the at least one verification detail correlating to the delivery; and
sending a configuration signal from the monitoring center to the access point, the configuration signal having instructions for controlling an entrance at the access point.

2. The method of claim 1, further including sending a second configuration signal from the monitoring center to the access point, the second configuration signal having instructions for controlling the entrance at the access point upon completion of the delivery.

3. The method of claim 1, wherein notifying a monitoring center of the arrival of the delivery includes using one of (a) a notification device integrated at the access point and (b) a notification device provided with the delivery.

4. The method of claim 1, wherein notifying a monitoring center of the arrival of the delivery includes using one of (a) a communication network integrated at the access point and (b) a communication network provided with the delivery.

5. The method of claim 1, wherein the at least one verification detail is selected from the group consisting of delivery location, time of day, shipper, freight manifest, PIN codes, ID cards, RFID tokens, biometric identifiers, barcodes, RFID tags, and license plates.

6. The method of claim 1, wherein the configuration signal includes instructions for disarming a burglar alarm subsystem at the access point.

7. The method of claim 1, wherein the configuration signal includes instructions for unlocking a door of the entrance at the access point.

8. The method of claim 1, further including remotely monitoring the delivery at the access point.

9. The method of claim 8, wherein remotely monitoring the delivery at the access point includes using one of (a) video monitoring and (b) audio monitoring.

10. The method of claim 8, wherein remotely monitoring the delivery at the access point includes using a data collection system to physically track items of the delivery.

11. The method of claim 10, further including printing a receipt of all items tracked as delivered.

12. The method of claim 1, further including remotely printing a delivery confirmation notice.

13. The method of claim 1, further including generating a delivery report.

14. The method of claim 13, wherein generating a delivery report includes transmitting the delivery report by one of (a) uploading the generated report to a webpage and (b) e-mailing the generated report.

15. The method of claim 1, further including sending an indication signal from the monitoring center to the access point, the indication signal having instructions for controlling an indicator at the access point.

16. The method of claim 1, further including establishing a logical monitoring area at the delivery location.

17. The method of claim 1, further including monitoring the delivery at the access point by multiple users.

18. The method of claim 17, wherein the multiple users simultaneously monitor the delivery at the access point.

19. The method of claim 1, further including issuing trouble signals for system malfunctions.

20. The method of claim 19, wherein the system malfunction is the loss of a monitoring connection with the customer premises equipment.

21. A monitoring center for monitoring and controlling customer premises equipment, the monitoring center comprising:
a monitoring server having a monitoring application,
a database, the database recording delivery data; and
a monitoring terminal in communication with the monitoring server, the database, at least one communication network and the customer premises equipment,
the monitoring server receiving a notification of an arrival of a delivery at an access point of the customer premises equipment, and verifying at least one verification detail that correlates to the delivery.

22. The monitoring center of claim 21, wherein the at least one communication network is a wireless network.

23. The monitoring center of claim 21, further comprising an electronic portal to provide access for authorized parties to the monitoring application.

24. The monitoring center of claim 21, further comprising an electronic publishing system for generating reports and notifications to authorized parties.

25. The monitoring center of claim 21, further comprising an email server.

26. The monitoring center of claim 21, further comprising an alarm receiver for receiving alarm signals from the customer premises equipment.

27. The monitoring center of claim 21, further comprising a web server.

28. A system for remotely monitoring deliveries, the system comprising:
customer premises equipment, the customer premises equipment including:
an access control system having a notification input device and a notification indicator, the access control system controls access to at least one door entrance of the customer premises equipment; and
a monitoring center for monitoring and controlling the customer premises equipment, the monitoring center including:
a monitoring server that contains a monitoring application,
a database for recording delivery data; and
a monitoring terminal in communication with the monitoring server, the database, at least one communication network and the customer premises equipment, the monitoring terminal receiving a notification of an arrival of a delivery at the at least one door entrance of the customer premises equipment and verifying at least one verification detail that correlates to the delivery.

29. The system of claim 28, wherein the customer premises equipment includes a media system in communication with the access control system, the media system manages voice and video data for the customer premises equipment.

30. The system of claim 28, wherein the customer premises equipment includes a burglar alarm system.

31. The system of claim 28, wherein the customer premises equipment includes an inventory management system.

32. The system of claim 28, wherein the customer premises equipment includes a printer.

33. The system of claim 28, wherein the customer premises equipment includes a card reader.

34. The system of claim 28, wherein the customer premises equipment includes a biometric input device.

35. The system of claim 28, wherein the customer premises equipment includes a motorized entrance door.

36. The system of claim 30, wherein a delivery location includes a logical delivery space, the burglar alarm system monitoring the logical delivery space to allow authorized deliveries within the logical delivery space and trigger an alarm if unauthorized activity is detected outside the logical delivery space.
